(19) United States
(12) Patent Application Publication
(10) Pub. No.: US 2026/0147842 A1
(43) Pub. Date: May 28, 2026

(54) EVENT-DRIVEN ARTIFICIAL INTELLIGENCE CONTENT GENERATION

(71) Applicant: Adobe Inc., San Jose, CA (US)

(72) Inventors: Viswanathan SWAMINATHAN, Saratoga, CA (US); Saayan MITRA, San Jose, CA (US); Gavin Stuart Peter MILLER, Los Altos, CA (US); Eunyee KOH, Sunnyvale, CA (US); Deepak PAI, Sunnyvale, CA (US)

(21) Appl. No.: 18/957,524

(22) Filed: Nov. 22, 2024

(51) Int. Cl. G06F 16/9535; G06F 16/9538

(52) U.S. Cl. CPC G06F 16/9535; G06F 16/9538

(57) ABSTRACT

Some aspects relate to technologies for dynamically generating digital content for events using event data and content intent descriptors. In some aspects, when a content server identifies an event for digital content creation, the content server provides data to a user device that is based on event data for the event and a content intent descriptor. The user device generates a prompt using the received data and provides the prompt to a generative model on the user device, causing the generative model to generate a digital content item using the prompt as input. The user device then presents the digital content item.

### BACKGROUND

A content delivery system is a platform or set of tools designed to distribute digital content over the Internet to target user devices effectively. This digital content can include, for instance, marketing content, recommendations, news, push notifications, or other information. Goals of content delivery systems include ensuring that the right digital content reaches the right audience at the right time and in the right format, and through the most appropriate channels.

### SUMMARY

Some aspects of the present technology relate to, among other things, dynamically generating content in response to events by leveraging a combination of event data for the events and content intent descriptors. In some configurations, the technology involves generating a digital content item directly on a user device in response to an event. A content server monitors online content to detect an event. When the content server detects an event for digital content creation, the content server provides data to the user device based on event data for the event and a content intent descriptor. The user device generates a prompt using this data and provides the prompt to an on-device generative model, which creates a digital content item using the prompt. The user device then presents the digital content item.

In other configurations, the technology involves generating a digital content item on a content server in response to an event and providing the digital content item to a user device for presentation. Upon identifying an event for digital content creation, the content server accesses event data for the event and a content intent descriptor. The server generates a prompt based on the event data and the content intent descriptor and provides the prompt to a generative model on the content server to create a digital content item. The content server then provides the digital content item to the user device for presentation.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

The present technology is described in detail below with reference to the attached drawing figures, wherein:

FIG. 1 is a block diagram illustrating an exemplary system in accordance with some implementations of the present disclosure;

FIG. 2 is a sequence diagram illustrating a sequence of actions performed by a content server and a user device to generate digital content on the user device using a content intent descriptor and event data for an event in accordance with some implementations of the present disclosure;

FIG. 3 is a flow diagram showing a method performed by a content server to cause a user device to generate digital content using a content intent descriptor and event data for an event in accordance with some implementations of the present disclosure;

FIG. 4 is a flow diagram showing a method performed by a user device to generate digital content on the user device using a content intent descriptor and event data for an event in accordance with some implementations of the present disclosure;

FIG. 5 is a block diagram illustrating another exemplary system in accordance with some implementations of the present disclosure;

FIG. 6 is a sequence diagram illustrating a sequence of actions performed by a content server and a user device to generate digital content on the content server using a content intent descriptor and event data for an event in accordance with some implementations of the present disclosure;

FIG. 7 is a flow diagram showing a method performed by a content server to generate a digital content item on the content server and provide the digital content item for presentation on a user device in response to an event in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, the term “digital content item” refers to digital media that can be presented by user devices and, in some cases, communicated over a network, such as the Internet. A digital content item can include one or more modalities, such as text, image, audio, and video. A digital content item can be any of a variety of different types. By way of example, in some aspects, a digital content item comprises marketing content (also referred to as a marketing message), intended to promote a product or service or to otherwise cause a potential customer to perform some action. In other aspects, a digital content item comprises other types of content, such as recommendations, news, push notifications, or other information.

As used herein, an “event” refers to an occurrence that triggers the generation of a digital content item regarding the event. In accordance with aspects described herein, events are identified by a content server by analyzing online content using any of a number of different techniques. For instance, data is collected from various online sources, including social media platforms, online news articles, blogs, and forums. From this data, methods such as keyword and hashtag analysis are used to detect potential events, which could involve identifying specific keywords or phrases related to events and monitoring trending hashtags that often signify popular or emerging events. In some configurations, entities (e.g., advertisers and other content creators) for whom digital content is being generated can specify particular keywords or phrases for use to identify events for each entity. This could be entity-specific, such that different events could be identified for different entities based on each entity's preferences.

The term “event data” is used herein to refer to any information related to a specific event that has been identified for the purpose of generating digital content. In accordance with aspects of the technology described herein, event data can include any information regarding an event that can be used to generate digital content associated with the event. For instance, the event data can include various attributes of the event, such as the time and date it occurred, the location, key participants or entities involved, and the nature of the event.

The term “content intent descriptor” is used herein to refer to a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

As used herein, the term “prompt” refers to input to a generative model that guides or otherwise instructs the generative model to generate a digital content item. In accordance with aspects of the technology described herein, a prompt is generated based on a content intent descriptor and event data, and, in some cases, also using on-device contextual data. A prompt can comprise any combination of text, images, audio, video, or other input format.

The term “on-device subscription data” is used herein to refer to information that is maintained on an end user's user device (e.g., a mobile device, tablet, or laptop computer) and that specifies the types of digital content the end user prefers to consume (or prefers not to consume). On-device subscription data can include information explicitly provided by an end user and/or information identified or otherwise determined by the end user's user device, for instance, based on user actions on the user device. In accordance with some aspects of the technology described herein, on-device subscription data on a user device is used by the user device to determine what digital content to present, essentially acting as a personalized content filter.

The term “on-device contextual data” is used herein to refer to information or metadata about an end user, such as an end user's characteristics, environment, behaviors, or circumstances that is maintained on the end user's user device, such as a mobile device, tablet, or laptop computer. On-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. On-device contextual data can include information explicitly provided by an end user and/or information identified or otherwise determined by the end user's user device, for instance, based on user actions on the user device. In some aspects, the on-device contextual data can include any information on the user device, such as information from calendar entries, emails, and text messages.

A “generative model” is a type of machine learning model that learns to generate output digital content from a given training dataset. Unlike discriminative models, which focus on predicting a label or class for input data, generative models aim to understand the underlying distribution of the data in order to generate output digital content. Generative models can generate output digital content by sampling from this learned distribution, in order to perform tasks like image generation and text synthesis. Examples of generative models include Variational Autoencoders (VAEs) and Generative Adversarial Networks (GANs). In some aspects, a generative model can comprise a large language model (LLM). In some aspects, the generative model can be a multi-modal model that operates on inputs and/or generates outputs of different modalities, such as text, image, audio, and video.

### Overview

Current content delivery systems often struggle with timely and relevant digital content generation in response to dynamic events. These systems typically rely on pre-scheduled content or manually generated content, which can lead to delays and a lack of personalization. Additionally, existing systems often fail to effectively leverage real-time data, resulting in digital content that fails to engage users or address their immediate interests and needs. This inability to dynamically generate digital content based on events results in digital content that is often outdated or no longer relevant.

Aspects of the technology described herein address these technical challenges by introducing a system for dynamically generating digital content in response to events as they occur. The system identifies events for content creation, gathers relevant event data, and generates prompts using this event data along with content intent descriptors. These prompts are then provided to a generative model to create digital content items, which are subsequently presented on user devices.

Some configurations described herein involve digital content generation on a user device in response to a content server identifying an event for digital content creation. In such configurations, the content server initially identifies an event. The content server identifies an event by analyzing online content using techniques such as keyword and hashtag analysis, natural language processing, and cross-referencing information from multiple sources. In some aspects, the content server also determines the sentiment of an event by performing sentiment analysis on the online content, and the content server selects the event for content creation if the sentiment is positive or neutral, filtering out events with predominantly negative sentiment.

After identifying an event, the content server provides data to a user device for digital content creation on the user device. The data communicated from the content server to the user device is based on event data for the event and a content intent descriptor, which, in some aspects, is selected based on the event. In response to receiving the data, the user device generates a prompt using the received data and provides the prompt to a generative model on the user device for generating a digital content item, which is then presented by the user device. In some aspects, the user device can employ on-device subscription data and/or on-device contextual data to determine whether to generate a digital content item for the received data and/or to personalize the digital content item.

Other configurations described herein involve digital content generation on a content server in response to the content server identifying an event for digital content creation. In such configurations, the content server identifies an event similar to the previously discussed configurations. After identifying the event and selecting a content intent descriptor, the content server generates a prompt using event data for the event and the content intent descriptor. The content server provides the prompt to a generative model on the content server, which generates a digital content item using the prompt as input. The content server then communicates the digital content item to a user device for presentation.

Aspects of the technology described herein provide a number of improvements over existing technologies. For instance, the technology described herein dynamically generates digital content in response to events, ensuring that the digital content is relevant to the event and provided to user devices in a timely manner. The technology also leverages content intent descriptors, which provide information for dynamically generating digital content for events when combined with event data for the events. Moreover, the use of generative models allows for the creation of diverse and engaging digital content tailored to specific events and information set forth in the content intent descriptors. Configurations in which the digital content item is generated on the user device allow for on-device contextual data to also be employed to personalize the digital content items. In configurations in which the digital content item is generated on the content server, the server-content generation approach allows for the use of more powerful server-side processing capabilities while still utilizing event data and content intent descriptors for dynamic content generation that is both relevant and timely.

### Event-Driven User Device Content Generation

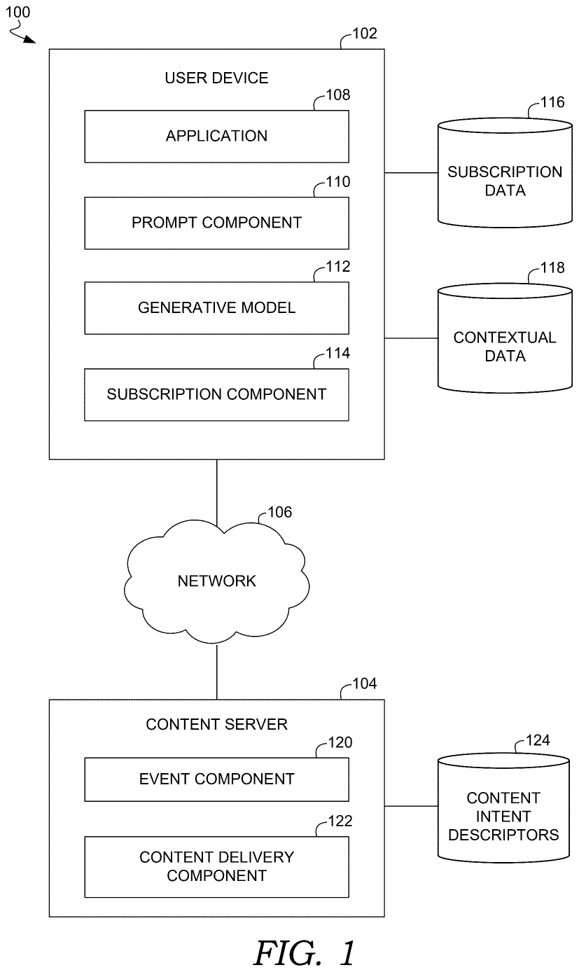

With reference now to the drawings, FIG. 1 is a block diagram illustrating an exemplary system 100 for generating digital content items on a user device using a content intent descriptor and event data in response to an event in accordance with some implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

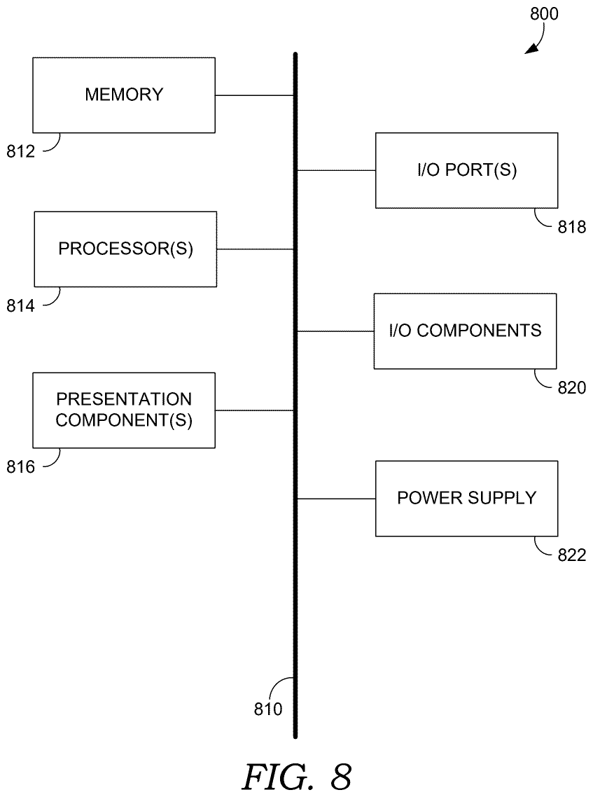

The system 100 is an example of a suitable architecture for implementing certain aspects of the present disclosure. Among other components not shown, the system 100 includes a user device 102 and a content server 104. Each of the user device 102 and the content server 104 shown in FIG. 1 can comprise one or more computer devices, such as the computing device 800 of FIG. 8, discussed below. As shown in FIG. 1, the user device 102 and the content server 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the content server 104 could be provided by multiple server devices collectively providing the functionality of the content server 104 as described herein. Additionally, other components not shown may also be included within the network environment.

The user device 102 can be a client device on the client-side of operating environment 100, while the content server 104 can be on the server-side of operating environment 100. The content server 104 can comprise server-side software designed to work in conjunction with client-side software on the user device 102 so as to implement any combination of the features and functionalities discussed in the present disclosure. For instance, the user device 102 can include an application 108 for interacting with the content server 104 and presenting digital content items on the user device 102. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the content server 104 remain as separate entities. While the operating environment 100 illustrates a configuration in a networked environment with a separate user device and content server, it should be understood that other configurations can be employed in which aspects of the various components are combined. For instance, in some aspects, aspects of the content server 104 can be implemented at least in part by the user device 102 and vice versa.

The user device 102 can comprise any type of computing device capable of use by a user. For example, in one aspect, the user device 102 can be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 102.

The content server 104 can be implemented using one or more server devices, one or more platforms with corresponding application programming interfaces, cloud infrastructure, and the like. While the content server 104 is shown separate from the user device 102 in the configuration of FIG. 1, it should be understood that in other configurations, at least some of the functions of the content server 104 can be provided on the user device 102 and vice versa.

As shown in FIG. 1, the user device 102 includes a prompt component 110, a generative model 112, and a subscription component 114; and the content server 104 includes an event component 120 and a content delivery component 122. The components of the system 100 may be in addition to other components that provide further additional functions beyond the features described herein. In some aspects, the functions performed by components of the system 100 are associated with one or more applications, services, or routines. In particular, such applications, services, or routines may operate on one or more user devices, servers, may be distributed across one or more user devices and servers, or be implemented in the cloud. Moreover, in some aspects, these components of the system 100 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The content server 104 is a computer system designed to store, manage, and deliver digital content over the network 106 to user devices, such as the user device 102. In accordance with aspects of the technology described herein, the content server 104 identifies events and causes the generation of digital content items on user devices, such as the user device 102, based on identified events.

To facilitate the generation of digital content for events, the content server 104 maintains a repository of one or more content intent descriptors, shown in FIG. 1 as the content intent descriptors data store 124. Each content intent descriptor is a data object that encapsulates information about the intended purpose and objectives of digital content to be generated and presented on a user device. A content intent descriptor can comprise data in different formats, such as text, images, audio, and/or video. By way of example only and not limitation, in the context of generating a marketing message, a content intent descriptor can comprise information regarding one or more products/services to be advertised. For instance, a content intent descriptor could include information based on a creative brief or a campaign brief that provides details for the creation of marketing content, which could include information regarding an objective, target audience, key message, tone, style, and type of digital content item to generate. In other instances, a content intent descriptor can specify information used to generate other forms of digital content items, such as recommendations, news, push notifications, or other information. Content intent descriptors can be defined by different entities, allowing each entity to have one or more descriptors tailored to their specific needs. For example, different advertisers can create unique content intent descriptors for their products, ensuring that the generated content aligns with their distinct marketing strategies and objectives.

The event component 120 of the content server 104 identifies events for which to generate digital content items using content intent descriptors. In particular, the event component 120 identifies events by analyzing online content using any of a number of different techniques. For instance, the event component 120 performs data collection from various online sources, including social media platforms, online news articles, blogs, and forums. From this data, the event component 120 employs methods such as keyword and hashtag analysis to detect potential events, which could involve identifying specific keywords or phrases related to events and monitoring trending hashtags that often signify popular or emerging events. In some configurations, entities (e.g., advertisers and other content creators) for whom digital content is being generated by the system 100 can specify particular keywords or phrases for use by the event component 120 to identify events for each entity. This could be entity-specific, such that the event component 120 identifies different events for different entities based on each entity's preferences.

In some aspects, the event component 120 employs natural language processing (NLP) to analyze online content and identify events. For instance, the event component 120 could use named entity recognition (NER) to identify and classify entities mentioned in online text. To ensure the accuracy of detected events, the event component 120 can use cross-referencing, comparing information from multiple sources to validate the occurrence and details of the event. The event component 120 can also employ temporal analysis, such as analyzing timestamps of posts and articles, to determine the recency of events and also measure how often an event is mentioned over a specific period to gauge its pervasiveness. In some aspects, the event component 120 identifies an event for content creation only if the event has a threshold level of online activity or pervasiveness, such as satisfying a threshold dictating a certain number of mentions. In some configurations, the event component 120 identifies an event for content creation only if the event has occurred within a threshold period of time.

The event component 120 can also perform sentiment analysis to determine the sentiment (positive, neural, or negative) of online content to understand the nature of the event. Sentiment analysis is a NLP technique used by computers to determine the emotional tone behind a body of text. By analyzing words, phrases, and contextual clues, sentiment analysis models categorize text as positive, negative, or neutral, sometimes with finer distinctions such as “very positive” or “slightly negative.” These models use pre-trained algorithms or machine learning techniques, often leveraging large datasets labeled for sentiment, to detect patterns that suggest certain sentiments. The sentiment analysis classifies the sentiment of the online content to understand public perception. In some aspects, the event component 120 filters out events with predominantly negative sentiment and identifies only positive or neutral events for content creation, as entities typically prefer not to associate their digital content with negative events.

When the event component 120 identifies an event for digital content creation, the content delivery component 122 on the content server 104 communicates, over the network 106 to a user device (e.g., the user device 102), data based on event data for the event and a content intent descriptor from the content intent descriptors data store 124. The content server 104 can select any number of content intent descriptors to generate digital content for a given event. For instance, in some aspects, contextual analysis can be performed on event data for an event and information from content intent descriptors to ensure the event is relevant to the specific interests or needs of the marketer or other entity for which digital content is to be generated for the event. This could include an assessment of the potential impact of the event on a target audience. In some aspects, entities providing content intent descriptors can specify, for each content intent descriptor, categories, keywords, or other information that is used by the content server 104 to identify relevant events for each content intent descriptor.

In some configurations, the data provided by the content delivery component 122 to the user device 102 comprises raw event data and a content intent descriptor without any preprocessing performed on the content server 104. In other configurations, the content server 104 performs some preprocessing on the event data and/or the content intent descriptor before providing the data to the user device 102. For instance, in some aspects, certain information from a content intent descriptor can be selected based on the event data. Similarly, certain information from the event data can be selected based on the content intent descriptor. In some aspects, the data provided from the content server 104 to the user device 102 for an event can be a prompt (generated from processing the event data for the event and a content intent descriptor) that can be provided as input to a generative model on the user device 102.

When the user device 102 receives data from the content server 104 based on a content intent descriptor and event data, the user device 102 uses the received data to generate a digital content item that is presented by the application 108 on the user device. More particularly, the user device 102 includes a prompt component 110 that provides a prompt for input to a generative model 112 to generate a digital content item. The prompt can be any input that guides the generative model 112 in creating a digital content item and can include various input formats such as text, images, audio, video, or a combination thereof.

The prompt component 110 generates the prompt using the data received from the content server 104. In some instances, the prompt component 110 simply provides the received data as input to the generative model 112 (i.e., the prompt is the data received from the content server 104 without further processing). In some aspects, the prompt component 110 provides a prompt (which could be pre-defined text) that instructs the generative model 112 to generate a digital content item using the received data. In further aspects, the prompt component 110 processes event data and/or content intent descriptor data in the received data to generate a prompt. For instance, in some aspects, the prompt component 110 can generate a prompt by selecting certain information from the content intent descriptor based on the event data. Similarly, the prompt component 110 can generate a prompt by selecting certain information from the event data based on the content intent descriptor.

In some aspects, the prompt component 110 uses on-device contextual data in conjunction with the data received from the content server 104 when generating a prompt. By leveraging on-device contextual data in conjunction with the data from the content server 104, the prompt component 110 can generate highly personalized and relevant prompts that guide the generative model 112 to create digital content items for events tailored to the end user's preferences and context. In such configurations, the user device 102 stores on-device contextual data in a contextual data store 118 maintained on the user device 102. The on-device contextual data includes information or metadata about an end user of the user device 102, such as the end user's characteristics, environment, behaviors, or circumstances. The on-device contextual data can include, for instance: user demographics (e.g., age, gender, etc.); user geolocation (e.g., through IP address or GPS data); user device information (e.g., device type, operating system, browser, etc.); user behavior data regarding actions such as page views, clicks, time spent on a website, or previous engagement with specific digital content items. The on-device contextual data can include information explicitly provided by the end user of the user device 102 and/or information identified or otherwise determined by the user device 102, for instance, based on user actions on the user device 102. In some aspects, the on-device contextual data can include any information on the user device, such as information from calendar entries, emails, and text messages.

In some aspects, the on-device contextual data is securely maintained on the user device 102 using one or more data security strategies. For instance, the on-device contextual data can be encrypted, ensuring that data is converted into a secure format that can only be accessed by authorized entities. This can be achieved, for instance, through full-disk encryption or file-level encryption. Access control mechanisms can also be employed that limit access to the on-device contextual data to specific applications via authentication. For instance, access to the on-device contextual data could be authorized for just the prompt component 110 such that other applications and components on the user device cannot access the data.

In configurations using on-device contextual data, the prompt component 110 uses the data received from the content server 104 and on-device contextual data in various ways to provide a prompt to the generative model 112. By way of example only and not limitation, in some aspects, the prompt component 110 simply provides the received data and on-device contextual data as input to the generative model (i.e., the prompt is the received data and on-device contextual data). In some aspects, the prompt component 110 provides a prompt (which could be pre-defined text) that instructs the generative model 112 to generate a digital content item using a combination of the received data and on-device contextual data. In some aspects, the prompt component 110 generates the prompt by selecting specific types of on-device contextual data that are relevant to the received data. For instance, if the received data includes a content intent descriptor that specifies generation of different content based on different age ranges, the prompt component 110 accesses age information for the end user from the on-device contextual data. In some aspects, the prompt component 110 uses on-device contextual data to select relevant information from the received data for use in generating the prompt. For example, if the received data includes a content intent descriptor that provides information for multiple products, the prompt component 110 could generate a prompt using information for one of those products that aligns best with the end user's recent behavior data, such as previous engagement with similar products.

In some configurations, the user device 102 can also use on-device subscription data to determine whether to generate and present digital content when the user device receives data for an event from the content server 104. As shown in FIG. 1, the user device 102 can also store on-device subscription data in a subscription data store 116 maintained on the user device 102. The on-device subscription data comprises information that specifies the types of digital content the end user prefers to consume (or prefers not to consume). The on-device subscription data can include information explicitly provided by the end user and/or information identified or otherwise determined by the user device 102, for instance, based on user actions on the user device.

In some aspects, the on-device subscription data is securely maintained on the user device 102 using one or more data security strategies. For instance, the on-device subscription data can be encrypted, ensuring that data is converted into a secure format that can only be accessed by authorized entities. This can be achieved, for instance, through full-disk encryption or file-level encryption. Access control mechanisms can also be employed that limit access to the on-device subscription data to specific applications via authentication. For instance, access to the on-device contextual data could be authorized for just the subscription component 114 such that other applications and components on the user device cannot access the data.

The on-device subscription data can be used by the user device 102 to determine what digital content to present, essentially acting as a personalized content filter. In such configurations using on-device subscription data, when the user device 102 receives data from the content server 104, the subscription component 114 on the user device 102 uses the on-device subscription data to determine whether to generate and present a digital content item on the user device 102 using the received data. The subscription component 114 compares the received data (or metadata associated therewith) to the on-device subscription data to determine whether to generate and present a digital content item. This can be done in a number of different ways. For instance, in some aspects, the subscription component 114 uses one or more of the following: keyword matching that determines if keywords from the received data (or from metadata associated therewith) match (or are similar to) keywords from the on-device subscription data;
category matching that compares a category of the received data to preferred (and/or undesired) categories in the on-device subscription data; preference scoring that assigns a score to the received data as a function of how well the received data matches the end user's subscription preferences set forth by the on-device subscription data; and using machine learning approaches to determine whether to generate digital content from the received data based on complex patterns in the on-device subscription data and/or the received data.

In some aspects in which the user device 102 employs on-device subscription data, the prompt component 110 can also use the on-device subscription data to select relevant information from the data received from the content server 104 for use in generating the prompt. For example, if the data for an event from the content server includes a content intent descriptor that includes information for multiple products, the prompt component 110 could generate a prompt using information for one of those products that aligns best with the end user's preferences as set forth by the on-device subscription data.

After the prompt component 110 generates a prompt from the data received from the content server 104, the prompt is provided as input to the generative model 112 to generate a digital content item, which is presented by the application 108 on the user device 102. In some aspects, the generative model 112 comprises a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes - all with limited to no supervision. Accordingly, an LLM can comprise a deep neural network that is very large (e.g., billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

The generative model 112 can comprise a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

In some aspects, the generative model 112 is optimized to fit on-device to perform content generations on user devices, such as the user device 102. The optimization of the generative model 112 can use any of a number of different techniques, such as pruning, quantization, knowledge distillation, and low-rank adaptation (LoRA). Implementing these techniques can make the generative model 112 more efficient and suitable for deployment on devices with limited resources, such as smartphones.

The generative model 112 in some configurations comprises a multimodal model having one or more neural networks (i.e., artificial neural networks) that provide an encoder-decoder architecture with a joint latent space for different modalities. As such, the generative model 112 can take input in one or more different modalities (e.g., text, images, audio, video, etc.) and generate an output in one or more different modalities (e.g., text, images, audio, video, etc.). By way of example only and not limitation, the generative model 112 can employ one or more of the following: a variational autoencoder (VAE), a generative adversarial network (GAN), a transformer, a cross-modal attention network, and a latent diffusion model.

When configured as a multimodal model, the generative model 112 can include separate encoders that generate latent representations of different input modalities. Each encoder comprises a neural network architecture that extracts features representing the input modality in a compressed, meaningful way. By way of example only and not limitation, text encoders for text data could employ recurrent neural networks (RNNs) or transformer-based architectures. Image encoders for image data could employ, for instance, convolutional neural networks (CNNs) or vision transformers. Audio and/or video encoders for audio/video data could employ, for instance, combinations of RNNs and CNNs (including 3-dimensional CNNs) or transformer-based architectures. In some configurations, the generative model 112 includes separate encoders for content intent descriptors and on-device contextual data.

The joint latent space of the multimodal model captures the underlying semantics of different modalities, allowing the model to understand and relate the information across the modalities. In order to provide combined latent representations of different modalities in the joint latent space, the model can also include a merging component that merges latent representations of different inputs (e.g., via concatenations, summation, average, and/or other fusion techniques). The combined latent representations in the joint latent space capture shared representations of different data types, allowing for interactions and transformations between modalities.

As a multimodal model, the generative model 112 can also include one or more decoders to generate outputs. Each decoder comprises a neural network architecture specialized to produce a specific type of output given a latent representation in the joint latent space. By way of example only and not limitation, text decoders to generate text data could employ RNNs or transformer-based architectures. Image decoders for generating image data could employ, for instance, convolutional neural networks (CNNs) or vision transformers. Audio and/or video decoders for generating audio/video data could employ, for instance, combinations of RNNs and CNNs (including 3-dimensional CNNs) or transformer-based architectures.

In some configurations, the generative model 112 is a pre-trained model (e.g., GPT-4) that has not been fined-tuned. In other configurations, the generative model 112 is a model that is built and trained from scratch or a pre-trained model that has been fine-tuned. In such configurations, the generative model 112 can be trained or fine-tuned using training data. The training data comprise, for instance, training samples that each include combined data from a sample event data and a sample content intent descriptor (and, in some cases, sample contextual data), as well as a ground truth digital content item. During training, weights associated with each neuron can be updated. Originally, the generative model 112 can comprise random weight values or pre-trained weight values that are adjusted during training. In one aspect, the generative model is trained using backpropagation. The backpropagation process comprises a forward pass, a loss function, a backward pass, and a weight update. The forward pass can include providing training data (e.g., sample event data with a sample content intent descriptor and, in some cases, sample contextual data) as input to the generative model 112, which generates an output based on that input. A loss can be determined based on the output and the ground truth digital content item from the training sample, and the weights updated based on the loss. This process is repeated using the training data. The goal is to update the weights of each neuron (or other model component) to cause the generative model 112 to produce relevant digital content items when given prompts based on content intent descriptors (and contextual data, in some cases). Once trained, the weight associated with a given neuron can remain fixed. The other data passing between neurons can change in response to a given input. Retraining the network with additional training data can update one or more weights in one or more neurons.

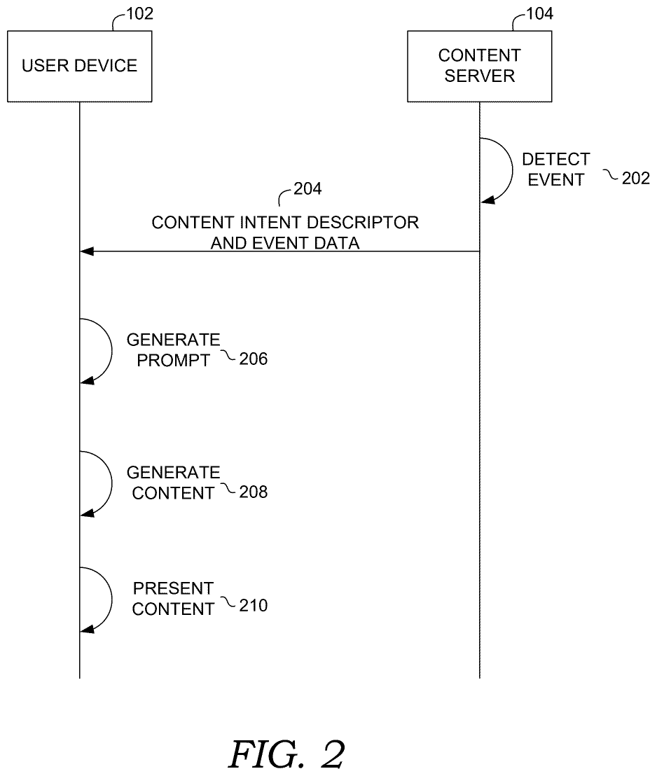

Turning next to FIG. 2, a sequence diagram is provided that shows a sequence of actions performed by the content server 104 and the user device 102 of FIG. 1 to generate digital content on the user device 102 using a content intent descriptor and event data for an event in accordance with some aspects of the technology described herein. At 202, the content server 104 detects an event for digital content creation. At 204, the content server 104 provides, over a network (e.g., the network 106) to the user device 102, data based on a content intent descriptor and event data for the event. The transmitted data can be raw event data and the content intent descriptor without preprocessing or can be data generated from preprocessing the content intent descriptor and/or event data on the content server 104.

Although not shown in FIG. 2, in some configurations, the user device 102 accesses on-device subscription data (e.g., from the subscription data store 116) and uses the on-device subscription data to determine (e.g., by the subscription component 114) whether the user device 102 is subscribed to present digital content based on the content intent descriptor and/or the event data. This can include comparing certain aspects of the received data to the on-device subscription data using one or more techniques.

At 206, the user device 102 generates (e.g., by the prompt component 110) a prompt using the data received from the content server 104. In some aspects, the user device also accesses on-device contextual data (e.g., from the contextual data store 118) and generates the prompt using the on-device contextual data in conjunction with the received event data. At 208, the user device 102 provides the prompt as input to an on-device generative model (e.g., the generative model 112), which outputs a digital content item based on the prompt. At 210, the user device 102 presents the digital content item (e.g., via the application 108).

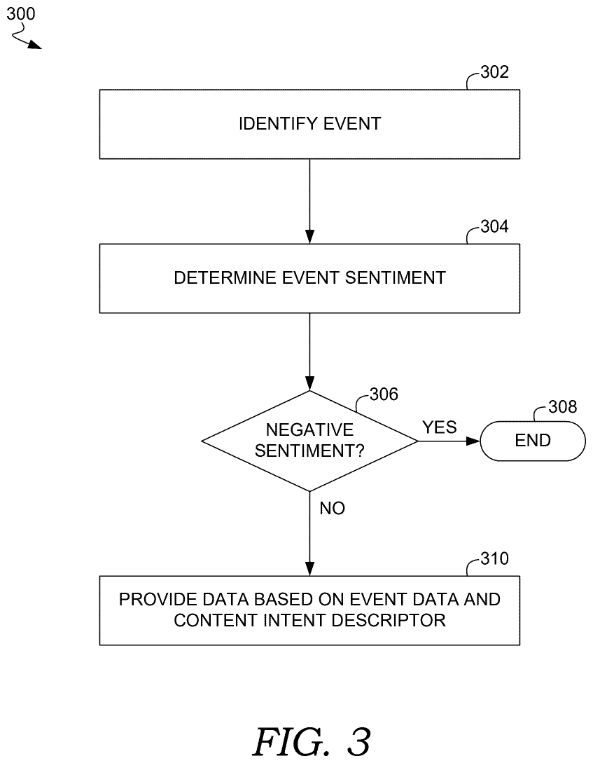

With reference now to FIG. 3, a flow diagram is provided that illustrates a method 300 performed by content server to facilitate the generation of a digital content item on a user device in response to an event. The method 300 can be performed, for instance, by the content server 104 of FIG. 1. Each block of the method 300 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, the content server identifies an event. The content server also determines a sentiment for the event, as shown at block 304. The content server determines at block 306 whether the event sentiment is negative. If so, the process ends, as shown at block 308. Alternatively, if the event sentiment is positive or neutral, the content server provides, over a network to a user device, data based on event data for the event and a content intent descriptor. In some aspects, the content server 104 selects the content intent descriptor for generating digital content for the event based on a comparison of the content intent descriptor (and/or metadata associated therewith) to information about the event. The data transmitted from the content server to the user device can be raw event data and the content intent descriptor without preprocessing or can be data generated from preprocessing the content intent descriptor and/or event data on the content server.

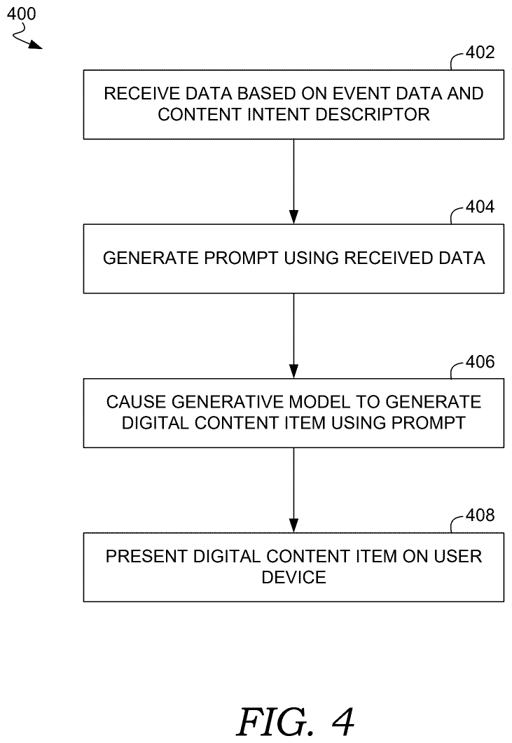

FIG. 4 provides a flow diagram showing a method 400 for a user device to generate and present a digital content item using a content intent descriptor and event data for an event. The method 400 can be performed, for instance, by the user device 102 of FIG. 1. As shown at block 402, a user device (e.g., the user device 102 of FIG. 1) receives, over a network from a content server (e.g., the content server 104 of FIG. 1), data based on a content intent descriptor and event data. Although not shown in FIG. 4, in some aspects, the user device can access on-device subscription data and use the on-device subscription data to determine whether the user device is subscribed to present digital content based on the content intent descriptor and/or the event data, and the process continues only if the user device determines it is subscribed.

As shown at block 404, the user device generates a prompt using the received data from the content server. In some aspects, the prompt is simply the received data without further processing. In other aspects, the prompt is generated by selecting certain data from the content event descriptor based on the event data and/or vice versa. In further aspects, the user device also employs on-device contextual data to generate the prompt. This could simply comprise providing the received data and on-device contextual data as input. In other aspects, this could include processing the received data and/or on-device contextual data to generate the prompt, such as selecting certain data from the content intent descriptor, event data, and/or the on-device contextual data based on the combination of data. For instance, certain data from the content intent descriptor can be selected based on the event data and/or on-device contextual data. Similarly, certain event data can be selected based on the content intent descriptor and/or on-device contextual data. Further, certain on-device contextual data could be selected based on the contentment intent descriptor and/or event data.

The user device provides the prompt as input to a generative model on the user device, causing the generative model to generate a digital content item using the prompt, as shown at block 406. Depending on the use case, the digital content item can comprise one or more modalities (e.g., text, images, audio, video, etc.). The user device then presents the generated digital content item, as shown at block 408.

FIGS. 1-4 illustrate configurations in which digital content items are generated on a user device using a generative neural network model (e.g., the generative model 112). In further aspects of the technology described herein, a script could be used in place of a generative neural network model to generate digital content items on a user device. In other words, in the context of FIG. 1, the script replaces the generative model 112 on the user device 102. The script could reside on the user device 102 or be provided by the content server 104 or another server. The script comprises code that, when executed by a user device, combines a content intent descriptor and on-device contextual data to generate a digital content item. For example, the content intent descriptor could be a template, and the script could populate portions of the template with on-device contextual data, such as the user's name or profile picture. Using such a script would typically not generate digital content items that are as rich as those provided by a generative neural network model, but the script could be executed on lower end devices as it has lower power and memory requirements relative to a generative neural network model.

### Event-Driven Server-Side Content Generation

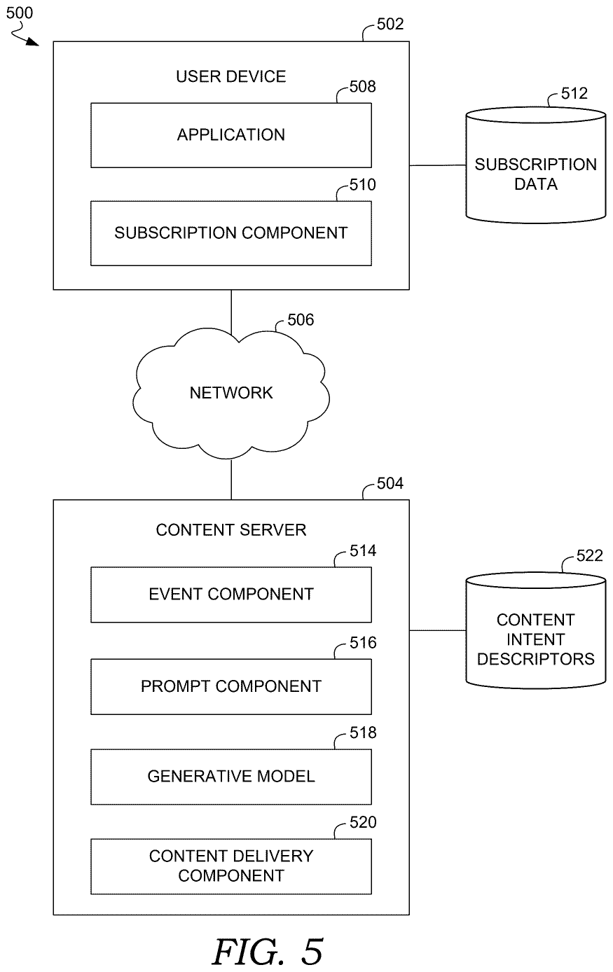

While FIGS. 1-4 illustrate a configuration in which digital content items are generated on user devices in response to events, FIGS. 5-7 illustrate a configuration in which digital content items are generated on a content server in response to events. With initial reference to FIG. 5, a block diagram is providing illustrating an exemplary system 500 for generating digital content items on a content server using content intent descriptors and event data for an event and providing the digital content items for presentation on user devices in accordance with some implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 500 is an example of a suitable architecture for implementing certain aspects of the present disclosure. Among other components not shown, the system 500 includes a user device 502, which can be similar to the user device 102 of FIG. 1, and a content server 504, which can be similar to the content server 104 of FIG. 1. Each of the user device 502 and the content server 504 shown in FIG. 5 can comprise one or more computer devices, such as the computing device 800 of FIG. 8, discussed below. As shown in FIG. 5, the user device 502 and the content server 504 can communicate via a network 506, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 500 within the scope of the present technology. Each may comprise a single device or multiple devices cooperating in a distributed environment. For instance, the content server 504 could be provided by multiple server devices collectively providing the functionality of the content server 504 as described herein. Additionally, other components not shown may also be included within the network environment.

The user device 502 can be a client device on the client-side of operating environment 500, while the content server 504 can be on the server-side of operating environment 500. The content server 504 can comprise server-side software designed to work in conjunction with client-side software on the user device 502 so as to implement any combination of the features and functionalities discussed in the present disclosure. For instance, the user device 502 can include an application 508 for interacting with the content server 504 and presenting digital content items on the user device 502. The application 508 can be, for instance, a web browser or a dedicated application for providing functions, such as those described herein. This division of operating environment 500 is provided to illustrate one example of a suitable environment, and there is no requirement for each implementation that any combination of the user device 502 and the content server 504 remain as separate entities. While the operating environment 500 illustrates a configuration in a networked environment with a separate user device and content server, it should be understood that other configurations can be employed in which aspects of the various components are combined. For instance, in some aspects, aspects of the content server 504 can be implemented at least in part by the user device 502 and vice versa.

The user device 502 can comprise any type of computing device capable of use by a user. For example, in one aspect, the user device 502 can be the type of computing device 800 described in relation to FIG. 8 herein. By way of example and not limitation, the user device 502 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. An end user can be associated with the user device 502.

The content server 504 can be implemented using one or more server devices, one or more platforms with corresponding application programming interfaces, cloud infrastructure, and the like. While the content server 504 is shown separate from the user device 502 in the configuration of FIG. 5, it should be understood that in other configurations, at least some of the functions of the content server 504 can be provided on the user device 502 and vice versa.

As shown in FIG. 5, the user device 502 includes a subscription component 510; and the content server 504 includes an event component 514, a prompt component 516, a generative model 518, and a content delivery component 520. The components of the system 500 may be in addition to other components that provide further additional functions beyond the features described herein. In some aspects, the functions performed by components of the system 500 are associated with one or more applications, services, or routines. In particular, such applications, services, or routines may operate on one or more user devices, servers, may be distributed across one or more user devices and servers, or be implemented in the cloud. Moreover, in some aspects, these components of the system 500 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 500, it is contemplated that in some aspects, functionality of these components can be shared or distributed across other components.

Similar to the content server 104 of FIG. 1, the content server 504 is a computer system designed to store, manage, and deliver digital content over the network 506 to user devices, such as the user device 502. In accordance with aspects of the technology described herein, the content server 504 identifies events and generates digital content items for presentation on user devices, such as the user device 502, based on identified events.

To facilitate the generation of digital content for events, the content server 504 maintains a repository of one or more content intent descriptors, shown in FIG. 5 as the content intent descriptors data store 522. The content server 504 also includes an event component 514, that identifies events for digital content creation similar to the event component 120 described above with reference to FIG. 1.

In contrast to the configuration in FIG. 1 in which digital content items are generated on user devices, digital content items are generated server side in the system 500. As shown in FIG. 5, the content server 504 includes a prompt component 516 and generative model 518 for server-side content generation. The prompt component 516 can be similar to the prompt component 110 of FIG. 1. Given event data for an event identified by the event component 514 and a content intent descriptor, the prompt component 516 generates a prompt. In some aspects, the prompt component 516 simply provides the event data and a content intent descriptor as input to the generative model 518 (i.e., the prompt is the event data and content intent descriptor without further processing). In some aspects, the prompt component 516 provides a prompt (which could be pre-defined text) that instructs the generative model 518 to generate a digital content item using the event data and content intent descriptor. In further aspects, the prompt component 516 processes event data and/or content intent descriptor data to generate a prompt. For instance, in some aspects, the prompt component 516 can generate a prompt by selecting certain information from the content intent descriptor based on the event data. Similarly, the prompt component 516 can generate a prompt by selecting certain information from the event data based on the content intent descriptor.

The content server 504 provides a prompt generated by the prompt component 516 to the generative model 518 on the content server, causing the generative model 518 to generate a digital content item. The generative model 518 can be similar to the generative model 112 of FIG. 1 (except for being located on the content server 504) and can generate digital content items similar to the discussion above for the generative model 112 in FIG. 1. The content delivery component 520 communicates the generated digital content item over the network 506 to the user device 502 for presentation on the user device 502 (e.g., via the application 508).

When the user device 502 receives a digital content item for a given event and content intent descriptor, the user device presents the digital content item, for instance, using the application 508. In some aspects, such as that shown in FIG. 5, the user device 502 maintains on-device subscription data in a subscription data store 512 maintained on the user device 502. The user device 502 also includes a subscription component 510 that can be similar to the subscription component 114 of FIG. 1. Given a digital content item from the content server 504 and on-device subscription data from the subscription data store 512, the subscription component 510 determines whether to present the digital content item on the user device 502.

In instances in which on-device subscription data is used, the subscription component 510 compares the digital content item (or metadata associated therewith) to the on-device subscription data to determine whether to present the digital content item. This can be done in a number of different ways. For instance, in some aspects, the subscription component 510 uses one or more of the following: keyword matching that determines if keywords from the digital content item (or from metadata associated therewith) match (or are similar to) keywords from the on-device subscription data; category matching that compares a category of the digital content item to preferred (and/or undesired) categories in the on-device subscription data; preference scoring that assigns a score to the digital content item as a function of how well the digital content item matches the end user's subscription preferences set forth by the on-device subscription data; and using machine learning approaches to determine whether to present the digital content item based on complex patterns in the on-device subscription data and/or the digital content item.

When the subscription component 510 determines that the user device 502 is not subscribed to the digital content item based on the on-device subscription data, the digital content item is not presented on the user device 502 and may be deleted from the user device. Alternatively, when the subscription component 510 determines that the user device 502 is subscribed to the digital content item based on the on-device subscription data, the user device 502 presents the digital content item.

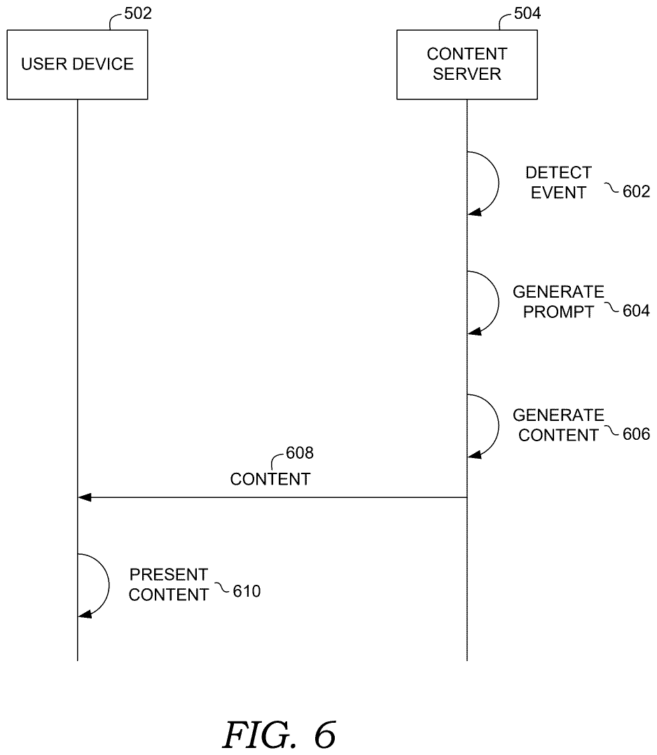

Turning next to FIG. 6, a sequence diagram is provided that shows a sequence of actions performed by the content server 504 and the user device 502 of FIG. 5 to generate a digital content item on the content server 504 using a content intent descriptor and event data for an event and to present the digital content item on the user device 502 in accordance with some aspects of the technology described herein. At 602, the content server 504 detects an event for digital content creation.

At 604, the content server 504 generates (e.g., by the prompt component 516) a prompt using the content intent descriptor and the event data. At 606, the content server 504 provides the prompt as input to a generative model on the content server 504 (e.g., the generative model 518), which outputs a digital content item based on the prompt. At 608, the content server 504 provides, over a network (e.g., the network 506) to the user device 502, the digital content item for the event. At 610, the user device 502 presents the digital content item (e.g., via the application 508).

Although not shown in FIG. 6, in some configurations, the user device 502 accesses on-device subscription data (e.g., from the subscription data store 512) and uses the on-device subscription data to determine (e.g., by the subscription component 510) whether the user device 502 is subscribed to present the digital content item. This can include comparing certain aspects of the digital content item (and/or metadata associated therewith) to the on-device subscription data using one or more techniques.

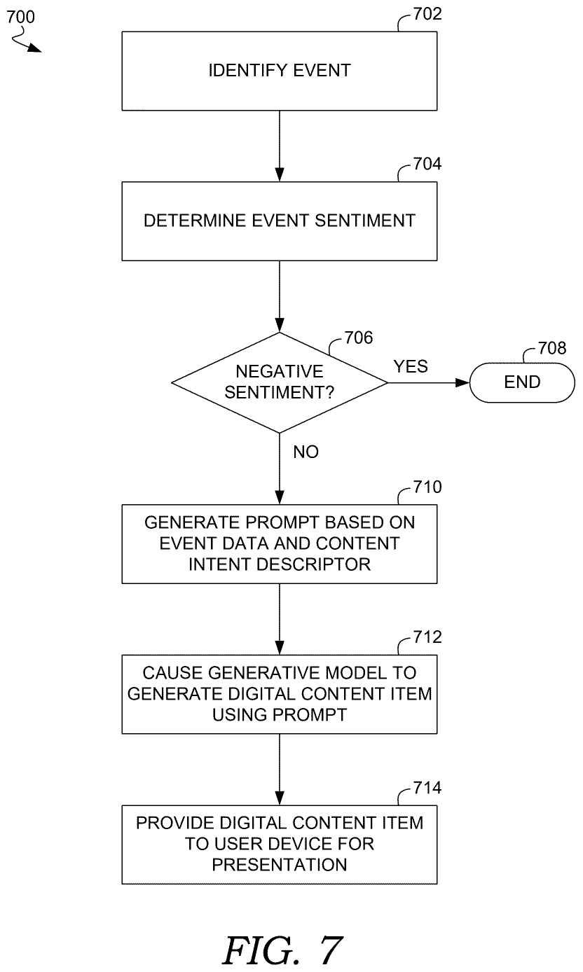

With reference now to FIG. 7, a flow diagram is provided that illustrates a method 700 performed by a content server to generate a digital content item on the content server and provide the digital content item for presentation on a user device in response to an event. The method 700 can be performed, for instance, by the content server 504 of FIG. 5. As shown at block 502, the content server identifies an event. The content server determines a sentiment for the event, as shown at block 704.

The content server determines at block 706 whether the event sentiment is negative. If so, the process ends, as shown at block 708. Alternatively, if the event sentiment is positive or neutral, the content server generates a prompt based on the event data and a content intent descriptor, as shown at block 710. In some aspects, the content server selects the content intent descriptor for generating digital content for the event based on a comparison of the content intent descriptor (and/or metadata associated therewith) to information about the event. In some aspects, the prompt generated at block 710 is simply the raw event data for the event and the content intent descriptor without further processing. In other aspects, the content server can process the event data and/or the content intent descriptor to generate the prompt, such as selecting certain data from the content intent descriptor based on the event data and vice versa.

The content server provides the prompt as input to a generative model on the content server, causing the generative model to generate a digital content item using the prompt, as shown at block 712. Depending on the use case, the digital content item can comprise one or more modalities (e.g., text, images, audio, video, etc.). The content server then provides the digital content item to a user device for presentation, as shown at block 714.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

1. One or more computer storage media storing computer-useable instructions that, when used by one or more computing devices, cause the one or more computing devices to perform operations, the operations comprising:
receiving, at a user device over a network from a server, data for an event identified by the server, wherein the received data is comprises event data for the event and a content intent descriptor, wherein the event data comprises information about an external occurrence detected by the server from one or more online sources, and wherein the content intent descriptor comprises a data object that provides information about an intended purpose and objectives of digital content to be generated;
generating, on the user device, a prompt using the event data and the content intent descriptor;
causing a generative model executing on the user device to generate a digital content item using the prompt; and
presenting the digital content item on the user device.

2. (canceled)

3. The one or more computer storage media of claim 1, wherein the prompt is generated on the user device by selecting information from the event data based on the content intent descriptor.

4. The one or more computer storage media of claim 1, wherein the prompt is generated on the user device by selecting information from the content intent descriptor based on the event data.

5. The one or more computer storage media of claim 1, wherein the received data comprises data generated by the content server from the event data and the content intent descriptor.

6. The one or more computer storage media of claim 1, wherein the prompt is generated using the received data and on-device contextual data maintained on the user device.

7. The one or more computer storage media of claim 6, wherein the prompt is generated by selecting information from the received data based on the on-device contextual data and/or the on-device contextual data is selected based on the received data.

8. The one or more computer storage media of claim 1, wherein the operations further comprise:
performing a comparison of on-device subscription data with the received data; and
determining to generate the digital content item based on the comparison.

9. The one or more computer storage media of claim 8, wherein the prompt is generated on the user device by selecting information from the received data based on the on-device subscription data.

10. A computer-implemented method comprising:
identifying, by an event component of a content server, an event that comprises an external occurrence detected by the server from one or more online sources;
determining, by the event component, a sentiment of the event as positive or neutral; and
responsive to determining the sentiment of the event as positive or neutral, communicating, by a content delivery component of the content server over a network to a user device, data based on event data that comprises information about the event and a content intent descriptor that comprises a data object that provides information about an intended purpose and objectives of digital content to be generated based on the event, wherein the data causes the user device to generate and present a digital content item by the user device generating a prompt using the data and providing the prompt to a generative model executing on the user device to generate the digital content item.

11. The computer-implemented method of claim 10, wherein identifying the event comprises:
analyzing online content to identify a threshold level of online activity associated with the event.

12. The computer-implemented method of claim 10, wherein the content intent descriptor is selected from a content intent descriptors data store based on the event data for the event.

13. The computer-implemented method of claim 10, wherein the data communicated to the user device comprises the event data and the content intent descriptor.

14. The computer-implemented method of claim 10, wherein the data communicated to the user device comprises information selected from the event data based on the content intent descriptor and/or information selected from the content intent descriptor based on the event data.

15. A content server comprising:
a content intent descriptors data store storing a plurality of content intent descriptors;
one or more processors; and
one or more computer storage media storing computer-useable instructions that, when used by the one or more processors, cause the content server to perform operations comprising:
identifying an event that comprises an external occurrence detected by the content server from one or more online sources,
accessing event data for the event and a content intent descriptor from the content intent descriptors data store, wherein the event data comprises information about the event and the content intent descriptor comprises a data object that provides information about an intended purpose and objectives of digital content to be generated based on the event, and
communicating, over a network to a user device, the data based on the event data and the content intent descriptor, wherein the data causes the user device to generate and present a digital content item by the user device generating a prompt using the data and providing the prompt to a generative model executing on the user device to generate the digital content item for presentation by the user device.

16. The content server of claim 15, wherein identifying the event comprises:
analyzing online content to identify a threshold level of online activity associated with the event.

17. The content server of claim 16, wherein identifying the event comprises:
determining a sentiment of the event based on the online content; and
selecting the event based on the sentiment being positive or neutral.

18. The content server of claim 15, wherein the content intent descriptor is selected from the content intent descriptors data store based on the event data for the event.

19. The content server of claim 15, wherein the prompt is generated on the user device by selecting information from the event data based on the content intent descriptor.

20. The content server of claim 15, wherein the prompt is generated on the user device by selecting information from the content intent descriptor based on the event data.
